(19) United States
(12) Patent Application Publication
(10) Pub. No.: US 2009/0275868 A1
(43) Pub. Date: Nov. 5, 2009

(54) SYSTEMS AND METHODS FOR JOINT REHABILITATION

(76) Inventors: Michael A. Steingart, Phoenix, AZ (US); David K. Reynolds, Scottsdale, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 12/114,650

(22) Filed: May 2, 2008

(51) Int. Cl. A61H 1/00; A63B 21/00; A63B 26/00

(52) U.S. Cl. 601/34; 482/92; 482/142

(57) ABSTRACT

In accordance with an embodiment of the present invention, a system is delineated for rehabilitating a knee of a patient when the patient sits on a seating surface. The system includes a base having a surface for supporting a portion of the patient in proximity to or including the knee of the patient where the surface does not move during operation of the system. In addition, the system includes a member rotatably coupled to the base for selectively moving a lower extremity of the patient, a driver for moving the member, and a controller for controlling the driver.

### FIELD OF THE INVENTION

The present invention relates to systems and methods for joint rehabilitation, and more specifically, to systems and methods for rehabilitating the knee of a patient in a sitting position.

### BACKGROUND OF THE INVENTION

Rehabilitation from an injury can be a difficult and painful experience lasting many months or even years. Sports injuries, car accidents, and other traumas can deprive a patient of full physical mobility. Similarly, disease or surgery, such as knee replacement or other knee surgery, can require long-term medical rehabilitation. Various implements are used to facilitate rehabilitation.

Continuous passive motion (CPM) is a treatment method designed to aid in the recovery of joints after surgery. CPM is carried out by a CPM system, which moves the affected joint through a range of motion, the range of motion being dependent upon the joint and the severity of joint damage, but in most cases, the range of motion is increased over time. The CPM mechanisms for aiding joint recovery are dependent upon the type of surgery that has been performed. Generally, CPM is used to reduce the adverse effects of trauma or immobilization following surgery. In physiological terms, through use of a CPM system, synovial fluid is diffused without hindering tissue repair, the affected joint receives nutrition, the flow of venous blood is increased, and the cartilage is prevented from deteriorating. From a clinical perspective, some benefits of a CPM system are: joint swelling (edema) is decreased, range of motion (ROM is maintained, tissue repair is accelerated, and the patient experiences less pain.

CPM systems are used as alternatives and adjuncts to conventional physical therapy following joint surgery or injury. CPM systems provide rehabilitative treatment following a wide range of surgeries, including arthroplasty, anterior cruciate ligament reconstruction, partial meniscectomy, and medial meniscus repair.

CPM systems are often used for bedridden surgical patients to reduce the incidence of deep-venous thrombosis, for treating abnormal muscle shortening that occurs due to prolonged immobilization, and for patients with burns or joint sepsis. It would be more beneficial, however, if such patients and others could receive this rehabilitation out of bed, where the patient could assume a natural upright position with increased mobility. CPM rehabilitation is often performed at a medical facility, while a patient lays supine or sits recumbently in a bed. Prolonged bed-rest often leads to bed sores, ulcers, thrombo phlebitis, deep-venous thrombosis, pulmonary edema, or lung congestion, leading to atelectasis or pneumonia. Moreover, performing joint rehabilitation in a bed may lead to the CPM system moving on the surface of the bed and/or the bed sheets becoming entangled in the moving parts of the CPM system. Additionally, traditional CPM systems are not suitable to accommodate patients of shorter stature, such as less than 5 feet tall, nor are they well suited for those with contractures of the knee or hip.

U.S. Pat. No. 7,175,602 ('602 patent) describes a portable CPM system for the knee. The '602 patent discloses a CPM system having a motor-assisted brace formed of multiple rigid assemblies mounted to the thigh and calf. The CPM system of the '602 patent suffers from numerous drawbacks. It can only be used while lying down or in a recumbent position on the floor or in a bed. Therefore, a patient who uses the CPM system of the '602 patent would still be prone to bed sores, ulcers, thrombo phlebitis, and other concerns associated with bedridden surgical patients.

None of the prior joint rehabilitation systems provide a patient with a solution that allows for knee rehabilitation in a true sitting-up position which provides dynamic positioning of the limb within the system, is easy to use, comfortable, applicable to either leg, and adjustable to the size of the patient. Accordingly, there existed a need to provide a new continuous passive motion knee rehabilitation system for patients in the upright sitting position.

### SUMMARY OF THE INVENTION

In accordance with an embodiment of the present invention, a system is disclosed for rehabilitating a knee of a patient when the patient sits on a seating surface, the system comprising a base having a surface for supporting a portion of the patient, the portion including any area in proximity to or including the knee of the patient, the surface not moving during operation of the system; a member rotatably coupled to the base for selectively moving a lower extremity of the patient; a driver for moving the member; and a controller for controlling the driver.

In accordance with another embodiment of the present invention, a method is disclosed for rehabilitating a knee of a patient when the patient sits on a seating surface, the method comprising providing a base having a surface for supporting a portion of the patient, the portion including any area in proximity to or including the knee of the patient, the surface not moving during the rehabilitating; providing a member rotatably coupled to the base for selectively moving a lower extremity of the patient; providing a driver for moving the member; and providing a controller for controlling the driver.

In accordance with yet another embodiment of the present invention, a method is disclosed for rehabilitating a knee of a patient when the patient sits on a seating surface, the method comprising supporting a portion of the patient on a surface of a base, the portion including any area in proximity to or including the knee of the patient, the surface not moving during the rehabilitating; selectively moving a lower extremity of the patient with a member rotatably coupled to the base; moving the member with a driver; and controlling the driver with a controller.

It is to be understood that both the foregoing general description and the following detailed description are exemplary and explanatory only and are not restrictive of the invention, as claimed.

The accompanying drawings, which are incorporated in and constitute a part of this specification, illustrate several embodiments of the invention and together with the description, serve to explain the principles of the invention.

### BRIEF DESCRIPTION OF THE EXEMPLARY EMBODIMENTS

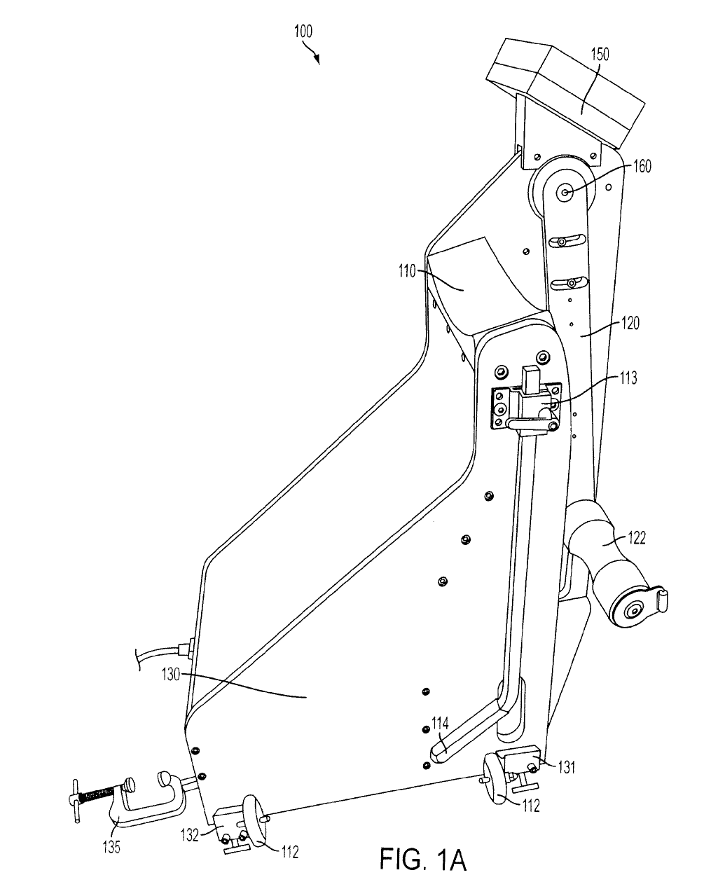

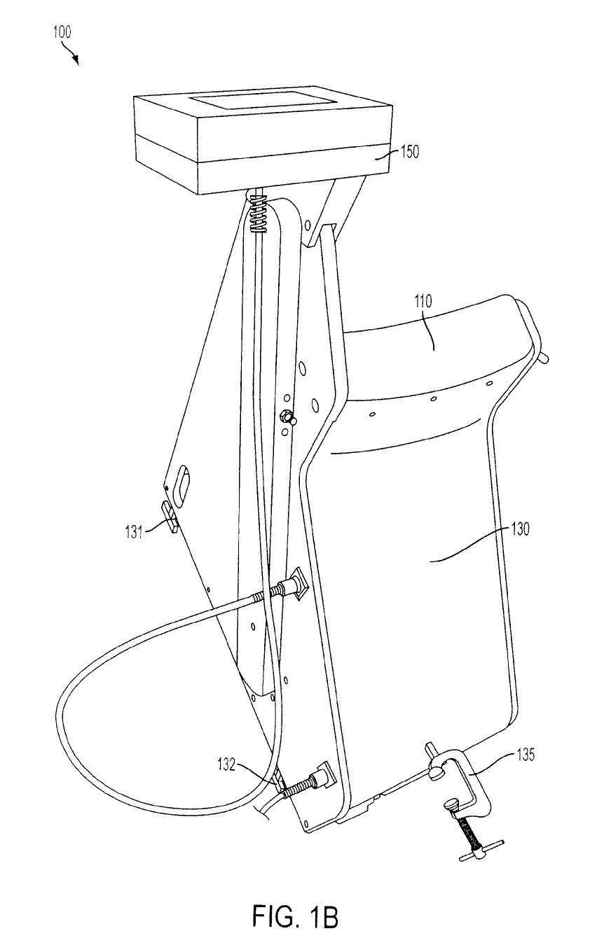

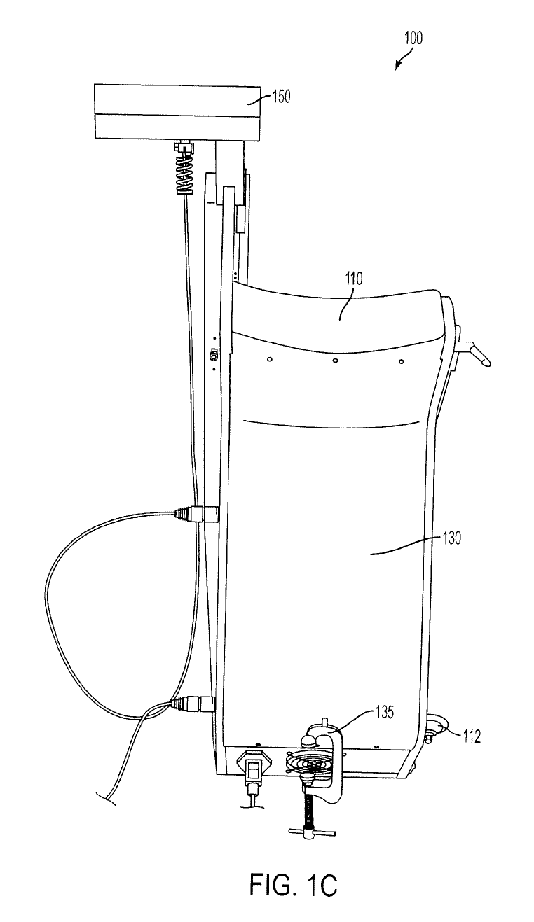

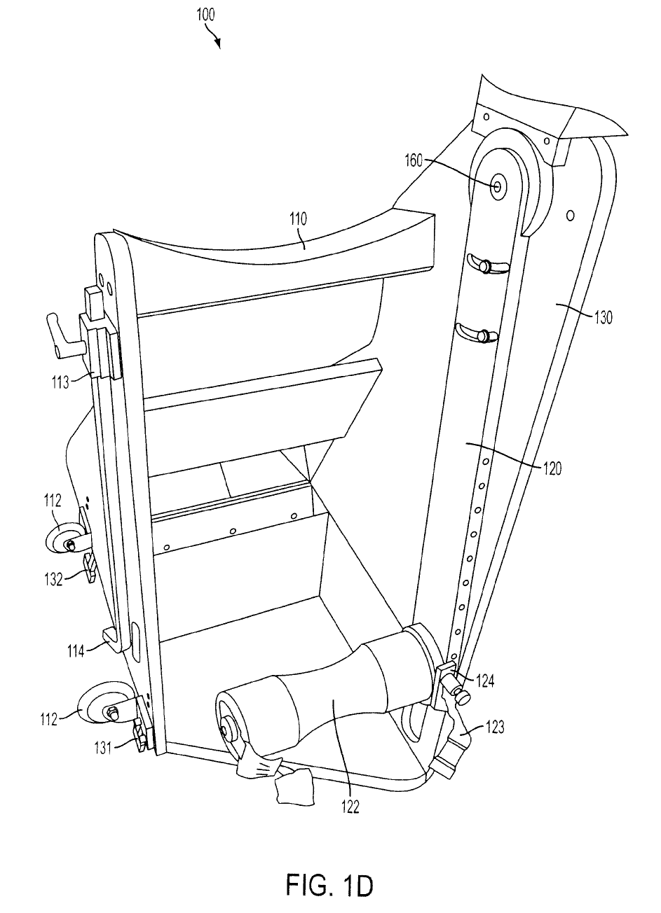

FIG. 1A is a perspective view of a system in accordance with embodiments of the present invention.

FIG. 1B is another perspective view of the system of FIG. 1A.

FIG. 1C is another perspective view of the system of FIGS. 1A and 1B.

FIG. 1D is a partial perspective view of the system of FIGS. 1A-1C.

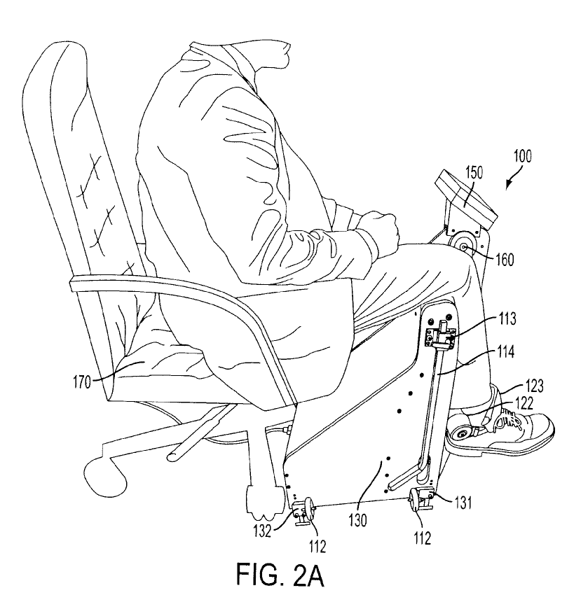

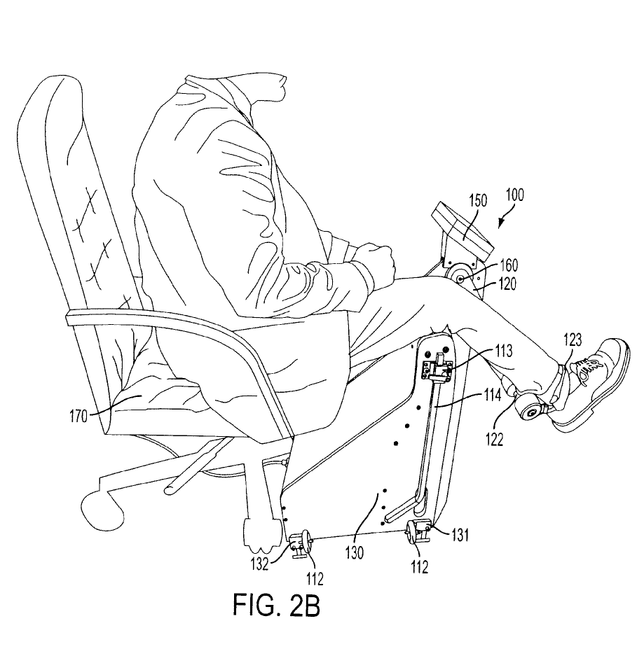

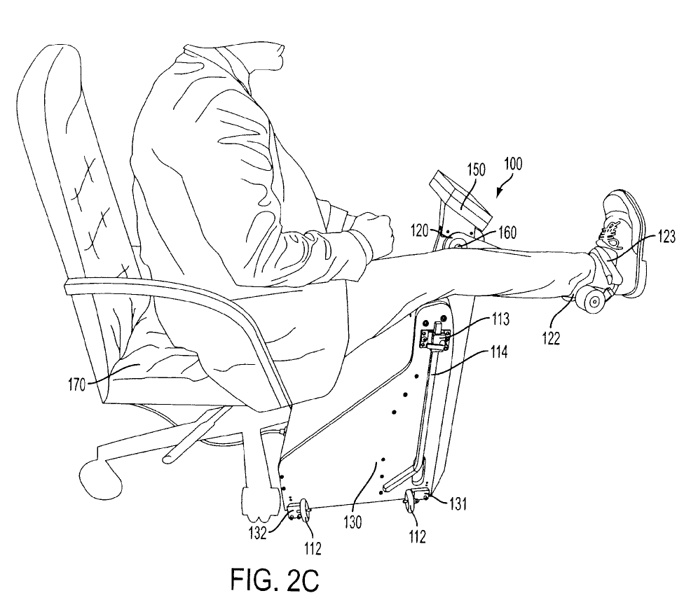

FIGS. 2A-2C is a sequence of perspective views showing a patient sitting upright on a seating surface and using the system of FIGS. 1A-1D.

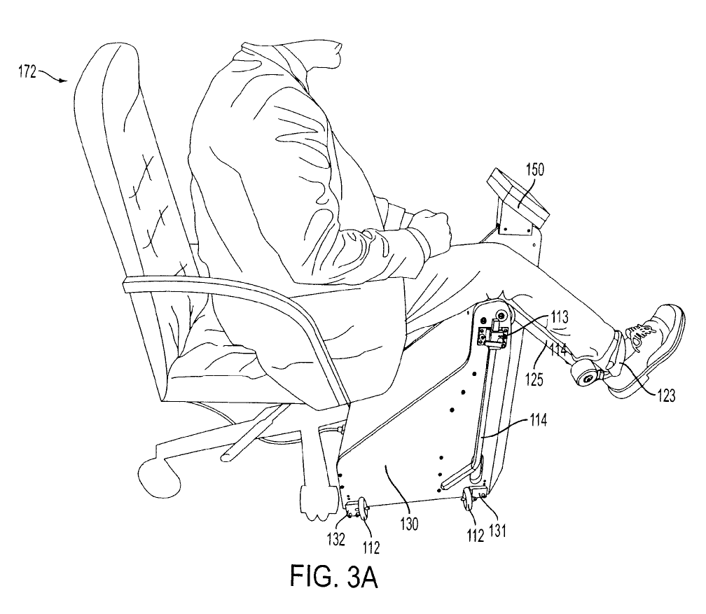

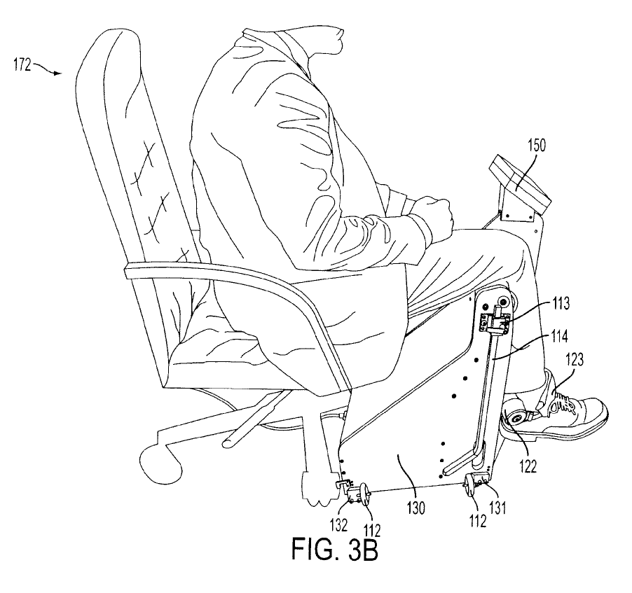

FIGS. 3A and 3B is a sequence of perspective views showing a patient sitting upright on a seating surface and using another system, in accordance with another embodiment of the present invention.

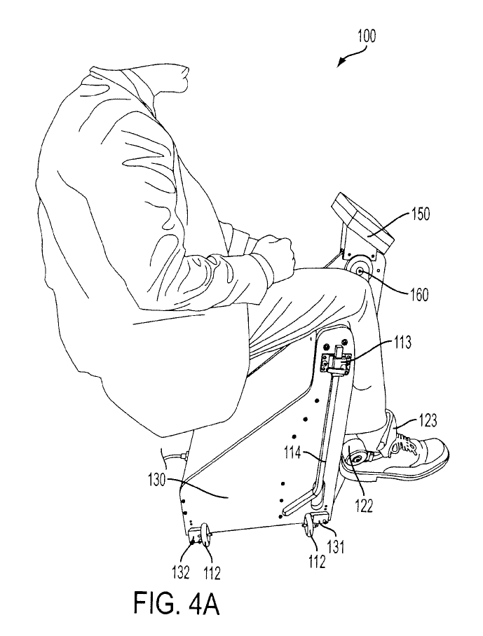

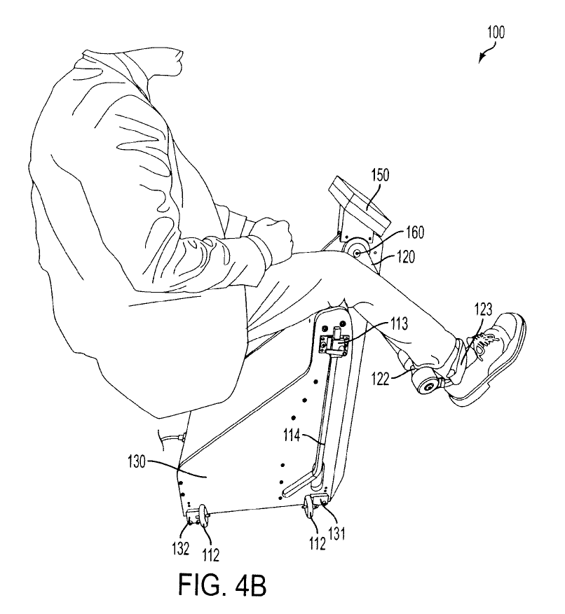

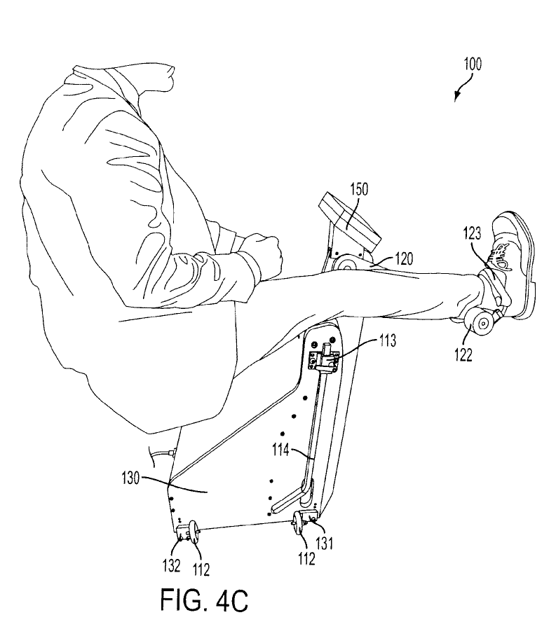

FIGS. 4A-4C is a sequence of perspective views showing a patient sitting upright on a seating surface and using the system of FIGS. 1A-1D.

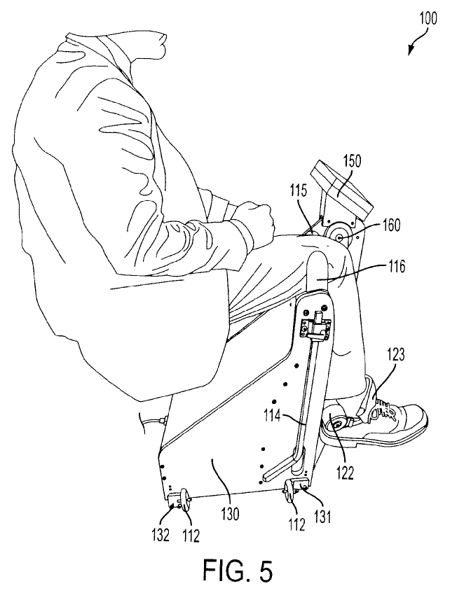

FIG. 5 is a perspective view showing a patient sitting upright on a seating surface and using the system of FIGS. 1A-1D.

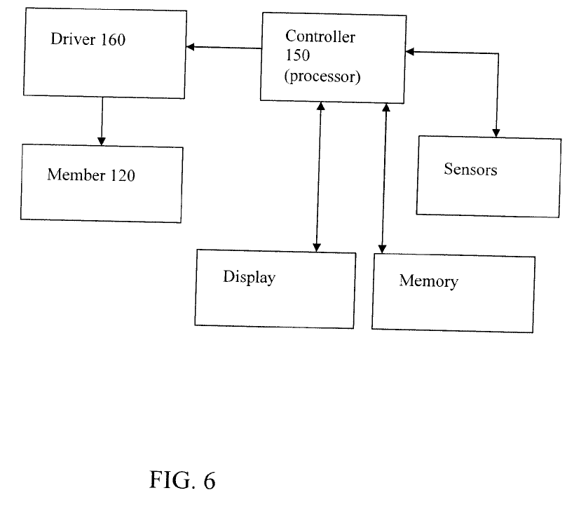

FIG. 6 is a block diagram of a control system, in accordance with embodiments of the present invention.

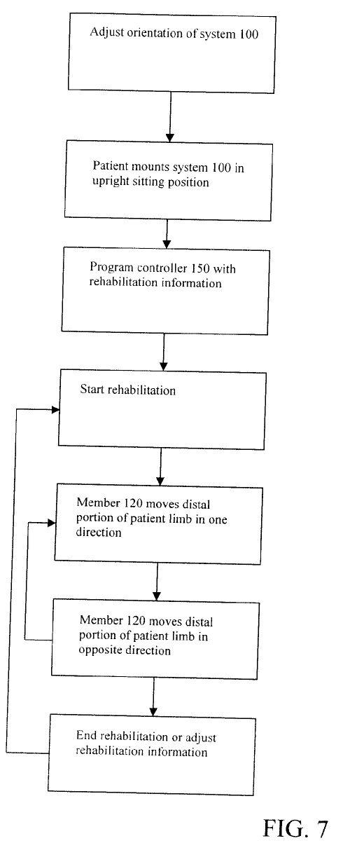

FIG. 7 is a flow chart depicting a process, in accordance with embodiments of the present invention.

### DETAILED DESCRIPTION OF THE EXEMPLARY EMBODIMENTS

Reference will now be made in detail to the exemplary embodiments of the present invention, examples of which are illustrated in the accompanying drawings. In accordance with an embodiment of the present invention, a patient may sit and employ a system 100 for rehabilitating a knee of the patient. The system includes a base 130 with a surface 110 for supporting the knee and a member 120 for selectively moving a portion of a lower extremity of the patient. This movement provides knee rehabilitation. The member 120 is moveably coupled to the base 130 by a hinge or pivot. The system 100 includes a driver 160 that moves the member 120 in a controlled manner moving the patient's leg through a desired range of motion for knee rehabilitation.

Referring to FIG. 1A, a perspective view is shown of a system 100 in accordance with an embodiment of the present invention. The system 100 comprises a base 130 having a surface 110 for supporting the knee of a patient and a member 120 on which a patient using the system 100 can place their leg. Additionally, the system 100 includes a driver 160 and a controller 150 for providing input control for the driver 160.

The base 130 comprises a housing on which elements of the system 100 are coupled. This base 130 is a robust structure capable of supporting any leg weight. The base 130 may be mounted by either the left, right or both legs of the patient.

The base 130 is designed to remain stationary during use. For instance, it may be constructed to be sufficiently heavy to maintain its position during use. Also, it is balanced so as to not tip during use. In accordance with an embodiment of the present invention, the base 130 may have a bottom surface fabricated of a rubber, adhesive, high tactile or other high-friction non-slip material to facilitate holding the base 130 in place during use. Alternatively, the base 130 may include fastening elements to fix its position during use or even when not in use. Referring to FIGS. 1A and 1B, the base 130 may be temporarily affixed to an anchoring structure such as a door frame or to a vertical pole by a C-clamp 135 that may be tightened around the anchoring structure. The C-clamp 135 may be used to temporarily affix the base 130 to any desired anchoring structure such as a horizontal pole or to an edge of a chair or a bench. In another embodiment, the base 130 includes wheels 112 and a grip 114 to aid in portability. The grip 114 is typically locked in place with a clamp 113, as shown in FIG. 1A, however, when a user wishes to move the base 130, the clamp 113 is loosened to position the grip 114, relock it with clamp 113 and then roll the base on the wheels 112. The orientation of the wheels 112 and grip 114 shall be such that they do not interfere with operation of the system 100.

Alternatively, the base 130 may be permanently affixed to an anchoring structure. For example, the base 130 may be bolted to a door frame, a vertical pole, a horizontal pole or to an edge of a chair or a bench. The patient or system operator may select a location where the base 130 should be bolted, and then permanently affix the base 130 to the selected location. In this context, “permanently” means the patient would have significant difficulty in moving the system 100 once the system 100 is bolted or otherwise anchored to the selected location.

The base 130 may also include a mechanism for selective raising and lowering thereof to achieve optimal rehabilitation orientation. For example, referring to FIGS. 1A-1D, the height of base 130 may be adjusted by extending and/or retracting adjustable platforms 131, 132. The adjustable platforms 131, 132 may level the base 130 on uneven surfaces or simply adjust the height of the base 130. While FIGS. 1A-1D show only four adjustable platforms 131, 132, more may be employed, if desired. In close proximity or coupled to the base 130 are a seating surface 170, as shown in FIG. 2A, and a surface 110 and a member 120, as shown in FIGS. 1A-1D.

Referring to FIG. 1A, the surface 110 provides a location for a patient to rest their thigh or the underside of their knee. The surface 110 may be coupled to the base 130, or in the alternative, a portion of the base 130 may comprise the surface 110. Referring to FIG. 1A, in one embodiment, the surface 110 may comprise the upper surface of a structure shaped to accept the natural contour of the leg of a patient. Alternatively, the surface 110 may be substantially flat. The structure providing surface 110 may be adjustable, using a conventional adjustment scheme. Accordingly, prior to system operation, the surface 110 may be suitably oriented to position the patient's leg for rehabilitation. For instance, if the patient is slightly reclined in an upright seated position on the seating surface 170, the surface 110 may be angled appropriately to comfortably accept a leg. During system operation, the surface 110 does not move from its set, locked position. As used herein with reference to the surface 110, the phrase “not moving” means the surface 110 does not move, with the possible exception that the surface 110 may be moved some minimal amount due to the movement of the patient during operation of the system 100.

In another embodiment, the surface 110 may include cushioning material. This cushioning material may provide comfort for the patient, such as through cushioning, animal skin, padding, synthetic material, or a liquid or an air-filled membrane. This cushioning material may comprise any suitable material to reduce risk of sores or ulcers during patient use. In another embodiment, the cushioning material may be removable for cleaning or replacement. In yet another embodiment, the surface 110 may have on it a removable hygienic layer. In another embodiment, the hygienic layer may comprise a portion of the surface 110. In either event, the hygienic layer may facilitate improved cleanliness for the patient.

In another embodiment of the present invention, the surface 110 include a restraint to assist in the proper positioning of the knee and isolation of the knee movement. This restraint may assist in keeping the patient in a desired position relative to the system 100. For instance, the patient may attempt to move out of proper positioning in the system 100 due to instinct or pain and the restraint will correctly maintain the position of the knee in the system 100.

Referring to FIG. 1A, the member 120 is used to move the lower extremity of a patient, such as the heel or shin. The member 120 is used to move the leg in an arcuate motion with a pivot point at the knee. The portion of the patient's leg located above the knee is not intended to move while the system 100 is in operation. The member 120 may comprise a lever arm, hingably coupled to the base 130 for a substantially arcuate movement.

FIG. 1A shows a driver 160 that is used to move the member 120, and a controller 150 that provides control input to the driver 160. The driver 160 moves the member 120 through any selected range of motion e.g., from a substantially horizontal orientation to a substantially vertical orientation or any range of motion therebetween. As the driver 160 rotates in the other direction, the member 120 returns to a substantially horizontal orientation from a vertical orientation. The hinge allows the member 120 to be moved in an arc by the force, from a substantially vertical orientation extending below the surface 110 to a substantially horizontal orientation extending in a direction away from the surface 110.

The member 120 may have a supporting region 122 for supporting a lower extremity of the patient. This supporting region 122 may reside at or near a distal end of member 120 and may be adjustably mounted thereto. Referring to FIG. 1D, the supporting region 122 may be integrally fitted with a bracket 124 that may be adjusted to various locations along the member 120 and secured to the member 120 by a removable pin. In an embodiment of the present invention, the supporting region 122 may extend perpendicularly from the member 120. If the patient were to sit on the seating surface 170 and the patient's leg under rehabilitation was to drape over the surface 110 along the member 120, the supporting region 122 may support behind the patient's leg. The supporting region 122 may support either leg or both legs. The supporting region 122 may be permanently affixed to and may be integrally formed with the member 120, however, supporting region 122 is usually adjustably fixed to the member 120, as described below.

As shown in FIG. 1D, the member 120 may have a supporting region 122 and bracket 124 secured by a removable pin. The removable pin may be inserted into a hole in the bracket and through a hole in the member 120, securing the supporting region 122 to the member 120. The patient or system operator may adjust the removable pin to allow the supporting region 122 to be aligned with a different hole of the member 120.

The member 120 may be made from any desired material. The member 120 may also include cushioned material to aid in comforting the patient, such as using sheepskin, lambskin, a synthetic cushion, a rubber-sponge, foam, padding, or air or liquid-filled material. This cushioning material may have any material suitable to help prevent sores or ulcers. The member 120 may have a removable hygienic layer. This hygienic layer may be placed on the member 120 or be integral to the member 120

In an alternative embodiment, the supporting region 122 may be implemented to extend both to the left and to the right from the member 120. The supporting region 122 may support both limbs of the patient at the same time. In this instance, however, the member 120 would be moved away from base 130 or the appropriate portions of base 130 would be removed to allow a supporting region 122 on both sides of member 120. Also, the surface 110 may be extended, if needed, to support both legs of the patient. Alternatively, the supporting region 122 may be suitably wide to accommodate both patients' legs while fastened to only one side of the member 120.

Referring to FIGS. 2A-2C, the supporting region 122 may be replaced or supplemented by an adjustable restraint 123. The adjustable restraint 123 may prevent the limb of the patient from slipping from the member 120. The adjustable restraint 123 may be any fastener to couple a lower extremity of the patient to the member 120. For example, the adjustable restraint 123 may comprise a strap that temporarily binds a limb of the patient to the member 120. The adjustable restraint 123 may use a hook-and-loop closure or VELCRO for fastening. The adjustable restraint 123 may be cushioned to aid in patient comfort. If desired, the adjustable restraint 123 may comprise a sleeve or a boot that may enclose a foot and/or a lower portion of a patient's leg. To use the system 100 with a sleeve, the patient may sit on the seating surface 170 and slide his/her foot and the lower portion of the leg into the sleeve, the sleeve being attached to the member 120. The sleeve may be adjustable to enclose a foot, regardless of the length of the leg. Additionally, the sleeve may further comprise a heel cup that prevents the limb from twisting within the sleeve.

FIGS. 2A-2C show a progression of movement of the member 120. In FIG. 2A, the member 120 is shown in a substantially vertical orientation. In FIG. 2C, the member 120 is shown in a substantially horizontal position. In FIG. 2B, the member 120 is shown in a partially extended orientation, between the retracted position of member 120, as shown FIG. 2A, and the extended position of a member 120, as shown in FIG. 2C. The range of motion may be set to any desired range.

Referring to FIGS. 2A-2C, in accordance with an embodiment of the present invention, the system 100 is in close proximity to a seating surface 170. This seating surface 170 may be substantially horizontal, such as a seat, a bench, the edge of a bed, or a table. If desired, the seating surface 170 may be reclined, inclined or angled forward for patient comfort or therapeutic need. The seating surface 170 may be adjusted to any desired position to facilitate any desired treatment, such as adjusting the position of the seating surface 170 to a desired position relative to the surface 110. The seating surface 170 may be made from any material. In one embodiment, cushioning material may be added to the seating surface 170 to aid in comfort of the patient, such as through using sheepskin, lambskin, synthetic cushioning, rubber-sponge, foam, padding, or air or liquid-filled material. This cushioning material may comprise any material suitable to help prevent sores or ulcers. The cushioning material may be removable or replaceable, as needed. In addition, the seating surface 170 may have a removable hygienic covering for hygienic multiple-patient use. This hygienic layer may be part of or placed on the seating surface 170. The seating surface 170 may be raised or lowered depending on patient height for optimal fit. In addition, the seating surface 170 may be moved closer or farther from the system 100 to accommodate varied height of the patient. In one embodiment, the seating surface 170 comprises an adjustable chair 172.

Referring to FIG. 3A and FIG. 3B, the adjustable chair 172 may be oriented in, and fixed to, any position or angle as determined for optimal patient comfort and rehabilitation. The adjustable chair 172 may be raised or lowered, as needed, and may include a lift mechanism to aid in patients exiting after use. Alternatively, the adjustable chair 172 may include a swivel and swivel lock for ease of mounting and using the system 100. The adjustable chair 172 may include removable arm rests and adjustable lumbar support. The adjustable chair 172 may include a transfer mechanism to aid in transfers from a wheel chair or other surface. Additionally, the adjustable chair 172 may include a convenient location for storing crutches or other walking implements during patient rehabilitation. The adjustable chair 172 may include a restraint or restraints to hold the patient in position during rehabilitation.

In yet another embodiment of the present invention, the base 130 and the seating surface 170 may be coupled together by any fastening system. This coupling may be temporary or permanent. Alternatively, the seating surface 170 and the base 130 may be independent. In another embodiment, the seating surface 170 may be temporarily fastened to a fixed position. For example, the seating surface 170 may be temporarily affixed to a door frame or to a vertical pole by a C-clamp that may be tightened around the door frame or vertical pole. The C-clamp may be used to temporarily affix the seating surface 170 to a horizontal pole or to an edge of a chair or bench.

In an alternative embodiment, as depicted in FIGS. 3A and 3B, a member 125 abuts the forward-facing wall of the base 130. This member 125 may be hingably coupled to the base 130. This member 125 may provide a wide region of patient support that reduces the risk of a patient's limb from disengaging with the system 100. The front face of member 125 may include an adjustable restraint 123 to promote safety and restrict lower extremity movement, such as through a padded strap or heal support.

FIG. 4A is a perspective view of another embodiment of the system 100. FIG. 4B is a second perspective view of a patient sitting on a seating surface (not shown), in accordance with FIG. 4A. The embodiment depicted in FIGS. 4A-4C is similar to that shown in FIGS. 2A-2C, except for a chair. In the embodiment shown in FIGS. 4A-4C, any seating surface may be employed, whether from a chair or otherwise. Indeed, any embodiment of the present invention may utilize any seating surface, whether provided by a chair or otherwise. The patient is seated on a seating surface so that the member 120 extends down angularly at an angle greater than 90°, relative to surface 110. The supporting region 122 supports the patient's foot from behind, while the member 120 may pivot about an attachment to the base 130. FIG. 4C is a third perspective view of a patient sitting on the system 100. The patient is seated on a seating surface so that the member 120 extends the patient's leg from the surface 110, at an angle of approximately 180°.

Referring to FIG. 4A, during one phase of each cycle of the driver 160, the driver 160 moves the member 120 to begin extending the leg at the knee. Referring to FIG. 4C, during another phase of each cycle of the driver 160, the driver 160 moves the member 120 to begin flexing or bending the leg at the knee. The driver 160 moves in a predefined manner that may be selected by user. Generally, the driver 160 moves slowly and with limited torque or adjustable torque, and provides an emergency-stop function for safety.

In a non-passive embodiment, instead of merely retracting and allowing the member 120 and the patient's leg to fall, or extending and lifting a patient's leg with the member 120, the driver 160 may provide resistance to the patient's effort, in either or both directions. Sensors may be provided for measuring the resistance applied to the member 120 by the patient. The patient may attempt to force the member 120 downward, using muscles of the limb, and the sensors can measure the force that the limb applies and respond accordingly, e.g., by adjusting the operational parameters of the driver 160. The data provided from the sensors may be provided to the controller 150, such that the controller 150 may adjust operational parameters of the driver 160 in response to the provided data and in a manner preset into the controller 150. Accordingly, the controller 150, when suitably programmed, may increase the range of motion and/or the force applied to the member 120, in response to an indication from one or more sensors that the patient may have improved muscle strength or other aspect of the limb. The controller 150 may be manually reset or incremented to a new setting while the system 100 is being used. If the patient or system operator decides to increase the range of motion, for example, the patient need only enter an appropriate command via the controller 150.

In another embodiment of the system 100, as seen in FIG. 5, the surface 110 may include flanges 116 to isolate the movement of the knee. The flanges 116 prevent knee movement, without interfering with the various post surgical healing incision points and medical lines, such as those from a stimulation unit or Hemovac system.

In accordance with each of the described embodiments of the present invention, the driver 160 is controlled by a controller 150, also hereinafter referred to as a controller 150 or a processor. Referring to FIG. 6, the controller 150 executes one of a plurality of programs that control any desired aspect of control for member 120 or member 125, such as the force, the speed, and the range of motion. The controller 150 may also measure the patient's use of the system 100. The controller 150 may have a readout or other output that allows one to obtain a record of the progress of the rehabilitation process as may be measured by the number of repetitions, the force applied, the speed, the angular range of motion, the total duration, and any other measurements that may be desirable for the controller 150 to obtain through sensors within the driver 160 or otherwise within the system 100. The controller 150 may include memory that may store the measurements and indicia of the program or programs being used. The measurements and indicia may be transferred to other systems, such as a hard drive, a network of computers, or may be printed out via a printer or displayed on a monitor or screen. Multiple profiles may be created so that different patients may store their personal historical, as well as current and future data. The measurements and indicia may be remotely accessed through a network by a user at a remote location.

The controller 150 may contain a microcontroller or a microprocessor that may execute a set of instructions in accordance with a firmware or software program. The instructions may modify operation parameters of the driver 160, such as speed, force, range of motion. For example, the instructions may alter the speed or timing of the driver 160, and thereby alter the speed or timing of the member 120 or member 125. The instructions may alternatively alter a force applied by the driver 160 to the member 120 or member 125. The instructions may alternatively reduce a range of motion, so that a patient with only limited physical mobility can use the system 100, or increase the range of motion for a patient without such a limitation. The controller 150 may be programmed to alter the operation parameters during a repetition, such that there is greater force when the patient begins to move his/her leg than when the leg is almost fully extended, or such that the limb is lifted more gently when the leg is almost fully extended than when the patient's leg begins to move. In an alternative embodiment, the controller 150 may pause the operation of the system 100 to allow for some active contraction by the patient, repositioning, or for the application of neuromuscular electrical stimulation.

The controller 150 may be coupled to the system 100 so that it is accessible by a patient or a system operator. In the alternative, a remote control may provide alternative control of the driver 160, i.e., it may send signals to control the controller 150.

Referring to FIG. 6, the member 120 or member 125 is moved by the driver 160. The driver 160 is coupled to the member 120, and executes instructions in accordance with the firmware or software program executing within the controller 150. In one embodiment, the driver 160 comprises an electric motor which drives and rotates an upper rotating body coupled to the member 120 or member 125. This electric motor may use a conventional power source and cooling system. In an alternative embodiment, the driver 160 may comprise a hydraulic motor for moving the member 120 or member 125.

Referring to FIG. 7, in embodiments of the present invention, the patient or system operator adjusts both the seating surface 170 and the base 130 for the patient's optimal rehabilitation orientation. For instance, this may involve raising the height of the base 130, adjusting the recline of the seating surface 170 to substantially horizontal (assuming a reclineable seating surface 170), and positioning the distance between the seating surface 170 and the base 130, so that the knee comfortably rests on the surface 110. The patient mounts the system 100 by sitting comfortably on the seating surface 170 and placing one or both legs over the surface 110 and the member 120 or member 125. The patient may and typically does remain in the upright sitting position throughout the rehabilitation. The patient rests the distal portion of their lower extremity (such as a shin or ankle) on the supporting region 122 and the underside of their knee on the surface 110. The supporting region 122 may be adjusted along the member 120 or member 125 for a desired fit to the patient.

Referring to FIG. 2A, the member 120 may be in a substantially 90° orientation where the leg is bent at the knee, or alternatively, referring to FIG. 2C, at the onset of rehabilitation, the member 120 may be in a substantially 180° orientation where the patient's limb is fully extended from the surface 110 horizontally. As seen in FIG. 2B, the member 120 may be mounted in a position between 90° and 180°, as needed for rehabilitation. Additionally, the member 120 may extend beyond the 180°, and under the 90° range if rehabilitation in this range is desired.

The adjustable restraint 123 is manipulated to secure the patients' lower extremity to the member 120 or member 125. The patient or a system operator provides input to the controller 150 to effect desired rehabilitation. The controller 150 controls the driver 160 according to a preprogrammed set of instructions. The patient or system operator enters rehabilitation information which may include any one or more of: number of repetitions, force applied, speed of motion, angular range of motion, total duration, and any other desired measurements for the controller 150. When the patient is ready to begin, the driver 160 moves the member 120 or member 125. The patient or system operator selects a suitable rehabilitation program and enters suitable rehabilitation information into the controller 150.

While rehabilitation is being performed, the patient's thigh may remain in a fixed location. The surface 110 does not move during system 100 operation. As used herein with reference to the surface 110, the phrase “not moving” means the surface 110 does not move, with the possible exception that the surface 110 may be moved some minimal amount due to the movement of the patient during operation of the system 100. While rehabilitation may describe restoration to a condition of good health, it may also describe general exercise or therapy performed, whether prefaced by an injury or a surgery or not.

It should be appreciated that the foregoing description of various embodiments of the present invention are not exhaustive, and are provided by way of example and not by way of limitation. Other embodiments of the invention will be apparent to those skilled in the art from consideration of the specification and embodiments disclosed herein. Thus, the specification and examples are exemplary only, with the true scope and spirit of the invention set forth in the following claims and legal equivalents thereof.

What is claimed is:

1. A system for rehabilitating a knee of a patient when the patient sits on a seating surface, the system comprising:
a base having a surface for supporting a portion of the patient, the portion including any area in proximity to or including the knee of the patient, the surface not moving during operation of the system;
a member rotatably coupled to the base for selectively moving a lower extremity of the patient;
a driver for moving the member; and
a controller for controlling the driver.

2. The system of claim 1, wherein the surface is curved to accommodate at least the knee of the patient.

3. The system of claim 1, wherein the member includes an adjustable restraint for securing a leg of the patient.

4. The system of claim 1, wherein at least one of the surface and the member includes removable hygienic material.

5. The system of claim 1, wherein at least one of the surface and the member includes cushioning material.

6. The system of claim 1, wherein the surface includes flanges to limit movement of the knee.

7. The system of claim 1, further including an attachment device for securing the base to a fixed location.

8. The system of claim 1, wherein the seating surface comprises a provided chair.

9. A method for rehabilitating a knee of a patient when the patient sits on a seating surface, the method comprising:
providing a base having a surface for supporting a portion of the patient, the portion including any area in proximity to or including the knee of the patient, the surface not moving during the rehabilitating;
providing a member rotatably coupled to the base for selectively moving a lower extremity of the patient;
providing a driver for moving the member; and
providing a controller for controlling the driver.

10. The method of claim 9, wherein the surface is curved to accommodate at least the knee of the patient.

11. The method of claim 9, wherein the member includes an adjustable restraint for securing a leg of the patient.

12. The method of claim 9, wherein at least one of the surface and the member includes removable hygienic material.

13. The method of claim 9, wherein at least one of the surface and the member includes cushioning material.

14. The method of claim 9, wherein the surface includes flanges to limit movement of the knee.

15. The method of claim 9, further comprising an attachment device for securing the base to a fixed location.

16. The method of claim 9, wherein the seating surface comprises a provided chair.

17. A method for rehabilitating a knee of a patient when the patient sits on a seating surface, the method comprising:
supporting a portion of the patient on a surface of a base, the portion including any area in proximity to or including the knee of the patient, the surface not moving during the rehabilitating;
selectively moving a lower extremity of the patient with a member rotatably coupled to the base;
moving the member with a driver; and
controlling the driver with a controller.

18. The method of claim 17, wherein the surface is curved to accommodate at least the knee of the patient.

19. The method of claim 17, wherein the member includes an adjustable restraint for securing a leg of the patient.

20. The method of claim 17, wherein the surface includes flanges to limit movement of the knee.
